(19) United States
(12) Patent Application Publication
(10) Pub. No.: US 2004/0261027 A1
(43) Pub. Date: Dec. 23, 2004

(54) Methods and apparatuses for streamlining the digital publishing of filmed video programs

(76) Inventors: Patrick Morton Dillon, Atlanta, GA (US); Frances Mueller Beltz, Westford, MA (US)

Correspondence Address: William R. Silverio, SUTHERLAND ASBILL & BRENNAN LLP, 999 Peachtree Street, NE, Atlanta, GA, 30309-3996, US

(21) Appl. No.: 10/457,142

(22) Filed: Jun. 9, 2003

(51) Int. Cl. G09G 5/00

(52) U.S. Cl. 715/723

(57) ABSTRACT

Methods for streamlining the publication of a digital version of a live video program concurrently with the filming of a live video program such that the program, or segments thereof, are published and available on a web page accessible via a WAN or the Internet immediately after the live event is recorded. Metadata tables and publishing instructions are inserted into the script of a program to be filmed to permit a publisher to identify and publish a filmed video program or segments thereof along with web publishing information. In particular, the video program and/or video program segments therein are tagged with the metadata that describe the video program and/or segments and permit the program and/or segments to be retrieved in a search.

### FIELD OF THE INVENTION

The present invention relates to methods and apparatuses for publishing video programs. More particularly, the present invention relates to methods and apparatuses for streamlining the publishing of a digital version of a video program, or digital versions of video program segments, such that the digital version(s) of the program and/or segments may be published immediately following the filming of a video program.

### BACKGROUND OF THE INVENTION

Today, high speed Internet and Wide Area Network (WAN) connections enable a user to download a variety of content and services not previously accessible due to downstream bandwidth limitations. For instance, high speed Internet connections such as those provided by DSL, T-1, and T-3 lines enable users to access a variety of bandwidth-intensive content, such as video and audio clips, interactive games, and business-related content accessed from a company network. As a result of these relatively new high-speed access channels, there has been a rapid increase in the number of services utilizing such bandwidth. However, despite ever-increasing download speeds to access bandwidth intensive content, there remains a significant hurdle in making large volumes of sizeable and reusable content available via the Internet, a WAN, or the like. This hurdle is the fast and timely assembly and publication of sizeable content, particularly video, in a digital format appropriate for downloading by a user.

Currently, publishing a video on a web page accessible via the Internet or a WAN requires that a pre-taped video be converted to a digital format, after which the digital video is uploaded to a web or network server so that it may be downloaded via the Internet or WAN. This process is time consuming because the transfer of a video into digital form requires that the video be replayed in full and that a programmer generate or customize a web page through which the video is identified and presented for downloading or viewing. The process is even more time consuming and difficult when a web publisher wishes to make only select segments of a video available on the Internet. Separate segments (i.e., video clips) of a video must be identified and converted into separate digital video streams, or an entire video must be converted into digital format after which the digital version is broken up into the requisite segments. After the separate segments are uploaded to a web server each is made available via the Internet or a WAN by providing HTML programming, or the like, identifying the separate segments.

In addition to identifying a video so it can be published and located for downloading or viewing, publishing a video also typically requires that web publishing information corresponding to or associated with the video (or segments thereof) be entered manually and stored on a web or network server. This is typically a time consuming process. As an illustrative example, where an instructional video having multiple segments is filmed, web publishing information may include the title, summary, run time, speaker(s) or actor(s), producer(s), and production date of the video and/or video segments. This information must be manually published and presented with each video segment so that a user can view the information. Other web publishing information associated with a video or video segment may include related videos and/or video segments. It will be appreciated that this information may be beneficial where a number of videos or video segments include a related series of videos or segments such as an instructional video course. Generating and associating web publishing information with video and/or video segments is also critical because the information typically permits search terms to identify one or more videos and/or video segments.

Unfortunately, the manual entry of such web publishing information is not only slow but also fails to tie a particular video segment together with its web publishing information. Tying video and its corresponding web publishing information together would be extremely useful to allow other digital video segments, digital videos, web pages, or programs to identify and present both the video and its corresponding web publishing information by specifying only the video segment. This clearly is advantageous in making large volumes of content available on one or more dynamically generated web pages immediately after a video event is filmed. Furthermore, when a video and its related web publishing information is tied together, the video and web publishing information may be easily re-used to generate numerous video programs.

It will be appreciated that the obstacles described above are applicable to video created using analog video recorders or digital video recorders. Though video filmed with digital video recorders need not be converted into digital form, uploading digital video also requires time-consuming data entry to publish web publishing information associated with the digital video. As with analog video, the creation and uploading of this web publishing information is neither immediate or automated. Therefore, the time required for publishing an analog or digital video, including any necessary digital conversion time and the time required for creating and publishing corresponding web publishing information, creates a time-consuming and costly task that often precludes a large volume of video from being made available via the Internet or a WAN. As such, after a video is filmed, it may take days or weeks to parse the video, extract the desired video segments, digitize the video, and assemble a web page having thereon the necessary web publishing information related to the video and/or its individual segments.

What is therefore needed are methods and apparatuses for streamlining processes associated with publishing a digital version of a video program, or digital versions of live video program segments, such that the digital version(s) may be published immediately after the video program is filmed. It would also be preferable if web publishing information associated with each video program or video segment is published with the video program and/or video program segments. Further, it would be preferable that a video and its corresponding web publishing information be related such that the video and its content may be simultaneously identified and re-used.

### SUMMARY OF THE PRESENT INVENTION

Methods and apparatuses according to the present invention simplify and streamline the processes associated with publishing a digital version of a filmed video program, or digital versions of filmed video program segments, to a web page. This streamlined publication process occurs concurrently with the filming of a video program such that the video, or segments thereof, are published and available on a web page accessible via a WAN or the Internet immediately after the live event is recorded.

More specifically, methods of the present invention insert metadata tables and publishing instructions into the script of a video program to be filmed. To effect the streamlined publication of video programs or video program segments, the metadata tables and publishing instructions permit a publisher or processor to identify and publish a filmed video program (or video segments therein) and all related web publishing information immediately after the program is filmed. The metadata tables and publishing instructions are expressly incorporated into the script during the writing of the script such that the methods of the present invention can utilize the metadata tables and publishing instructions to publish immediately individual or multiple video segments in a segmented format (e.g., an online instructional video course broken down into course segments, or modules).

According to one aspect of the present invention, the metadata tables identify video and video segments within a script, and contain data describing the video program and/or video segments. For instance, a metadata table may specify the format, location, and organization of a video program or an individual video segment to be published on the web. As referred to herein, after publication on the web, the video segments include video modules, and the video program includes a video package or course. The metadata describing the video program and/or video segments not only associates the web publishing information with a video program and/or video segments, but also permits the video program and/or segments to be retrieved in a search of terms included within the metadata.

According to one aspect of the present invention, the publishing instructions within the script include general information utilized by a publisher to generate a web-based video course or video module. As an illustrative example, publishing instructions may include web-screen layout and presentation information. As another example, the publishing instructions may instruct the publisher to omit a particular video segment in the web publication that is otherwise included in an analog version of the program.

It will be appreciated that an illustrative embodiment used throughout the present disclosure pertains to the publishing of an instructional video that includes multiple video segments. Using the methods and apparatuses of the present invention, the instructional video may be published on the Internet as an instructional video course broken down into individual web-based course modules, where each web-based course module corresponds to a respective video segment of the instructional video. The course modules are independently accessible and identifiable by an Internet user. In such a scenario, the metadata tables and publishing instructions identify and associate video or video segments with web content associated with the respective video or video segments. For instance, publishing instructions may identify and associate content, such as audio, graphic files, etc., used to produce each video program segment, such that a publisher may immediately publish each segment as a separate module within an online video course after it is filmed.

The present invention is also described herein with respect to learning objects. Learning objects represent objects, such as analog or digital video segments (prior to publication) or modules (after publication), which can be used, reused and referenced. The present invention enables the identification of such learning objects beginning at the design and script writing stages of a video production. As will be described herein, learning objects can be aggregated, or grouped with additional learning objects, into larger collections of content to create more substantial units of content, such as a collection of video segments pertaining to a particular topic. Learning objects contain content and metadata describing the focus of the learning object and its content. As described in the present disclosure, metadata can therefore describe and place in context a video segment published to the web as a video module. Metadata may include objective and subjective information, including the type of object, author, owner, format, and subject matter necessary for publishing a video segment to the Internet and for associating it with additional video segments or videos. Furthermore, because learning objects are tagged with metadata describing, e.g., the subject matter of a learning object, the learning object may be easily retrieved in a search.

It should be appreciated that although the examples described herein relate to the publishing, on a web page, of one or more videos or video segments directed to learning material, the examples and illustrations described herein are non-limiting. The present invention is operable to effect the immediate publication of video and content associated with any scripted filmed event, such as movies and newscasts. Furthermore, the present invention may extend to live events that do not utilize a script, such as sporting events. Though such events are not typically scripted, they usually include fundamental events (events defined by the nature of each sport, such as time-outs, scoring events, etc.) that may be utilized by the methods and apparatuses of the present invention to determine and parse natural edit points making it possible to publish a live program, or segments thereof, on a web page. Thus, it will be appreciated that the present invention may be extended to applications beyond those expressly discussed herein.

### BRIEF DESCRIPTION OF THE DRAWINGS

Having thus described the invention in general terms, reference will now be made to the accompanying drawings, which are not necessarily drawn to scale, and wherein:

FIG. 1 shows a block diagram flow chart illustrating a process for publishing an analog video in a digital format according to the prior art.

FIG. 2 shows a block diagram flow chart illustrating a streamlined video publication process, according to an illustrative example of the present invention.

FIG. 3 shows a block diagram illustrating the streamlined video publication process of the present invention, and devices for storing and downloading published video, according to one embodiment of the present invention.

FIG. 4 shows a block diagram flow chart describing a method for streamlining the publication of a video to a web page, according to one embodiment of the present invention.

FIG. 5 shows an illustrative script including metadata contained therein for use in creating, delivering, and publishing a video, according to one aspect of the present invention.

FIG. 6 shows a block diagram view of a learning object, according to one aspect of the present invention.

FIG. 7 shows a block diagram view of a learning object including embedded learning objects, according to one aspect of the present invention.

FIG. 8 shows an illustrative example of a learning object forming a course, according to one aspect of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

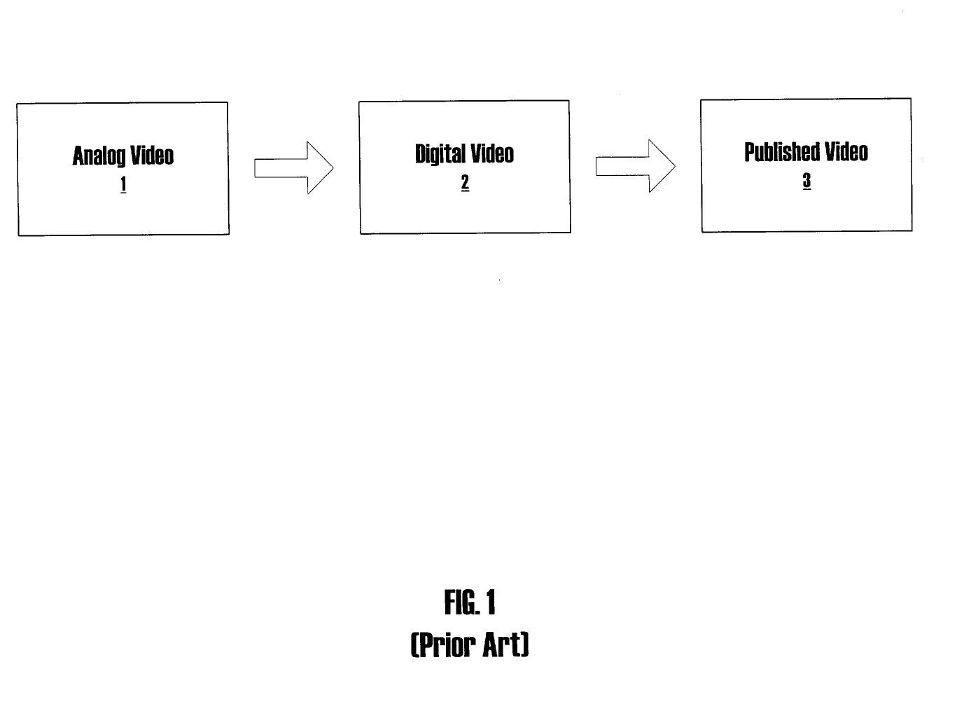

FIG. 1 shows a block diagram flow chart illustrating a process for publishing an analog video 1 in a digital format according to the prior art. The analog video 1 is first converted to digital video 2 using a process known to those of skill in the art, such as MPEG-2 compression. The conversion may be executed by a computer executing analog to digital video conversion software, as is also known in the art. After the analog video 1 is converted into digital video 2 it is published.

Publishing the digital video 2 typically includes uploading the video to a web or network server accessible to the user and presenting the video, or a link to the video, to a user viewing a web page or the like. The published video 3 may contain a title or other information (e.g., run time, summary, etc.) presented to users who may view or download the digital video. Using conventional publication methods, such information must be manually entered using HTML, XML, or a like programming language so that the information is available to a network or Internet user. Such a process is described in the Background of the Invention, and is time consuming because each video segment must be identified and stored on a web server individually. Furthermore, any information associated with the digital video 2 must be manually entered by a programmer so that it is available on the Internet. This process fails to tie together the generation of a digital video to its related publication information (e.g., title, run time, description, etc.). Because the method of publishing an analog video on a web page as described above is well known to those of skill in the art, it is not described in greater detail herein.

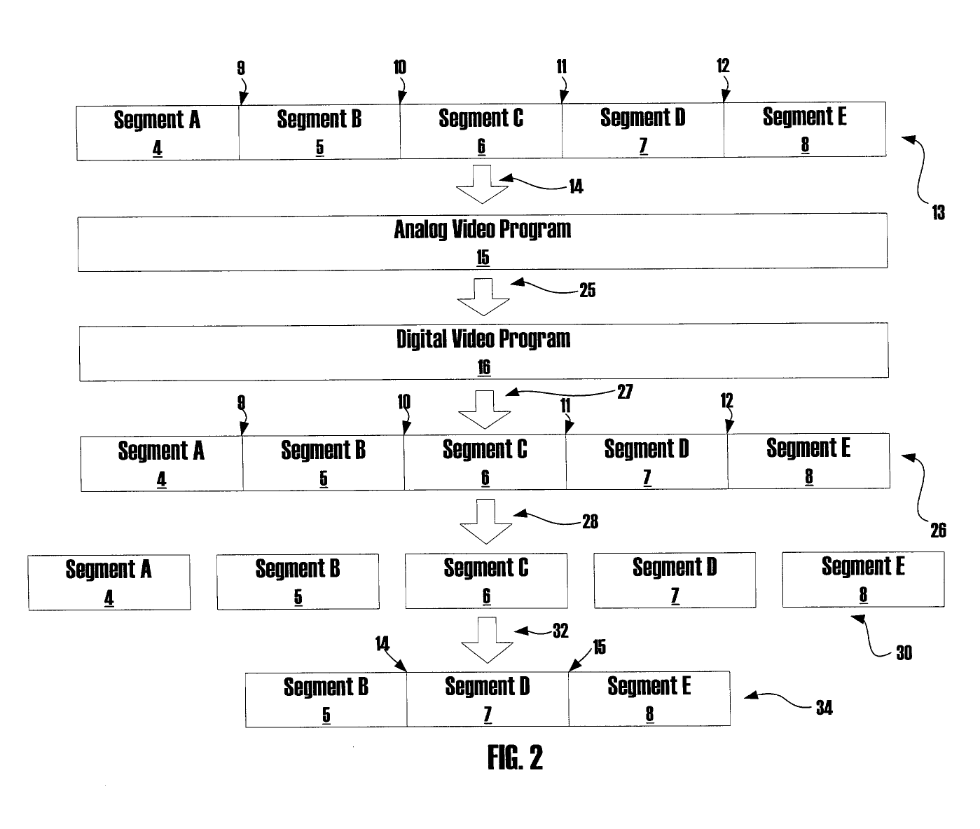

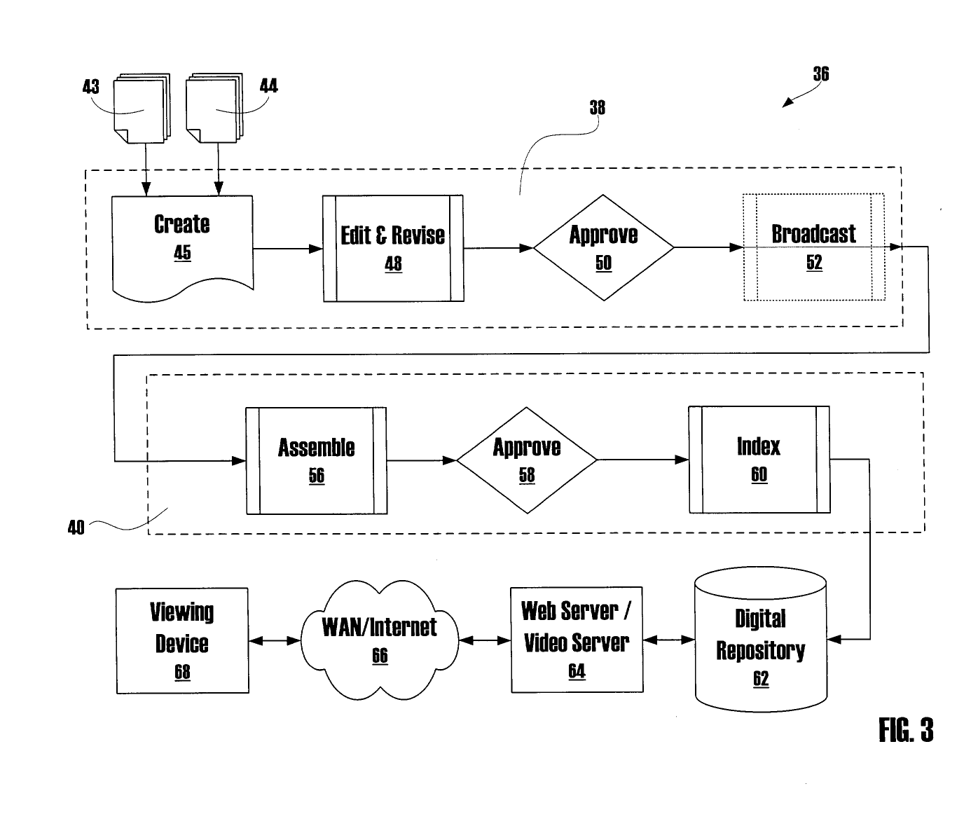

FIG. 2 shows an illustrative block diagram flow chart showing a streamlined video publication process of the present invention, according to one embodiment of the present invention. In particular, the illustrative example shown in FIG. 2 shows the basic video processing steps implemented using the methods and apparatuses of the present invention to convert an illustrative analog or digital video program into one or more video programs or video segments. The methods and apparatuses used to effect these processing steps are disclosed in greater detail below with reference to FIGS. 3-8.

It will be appreciated that the publication process of the present invention provides a significant departure from prior art methods of publication because the publication process utilizes content inserted into the script during script design and development to make web publication easier, quicker, and more cost effective. This streamlined process includes the ability to generate indexing information utilized by an Internet web page to allow a user to locate and download the live video program, or segments thereof. This streamlined publication process also occurs concurrently with the filming of a live video program such that the program, or segments thereof, are published and available from a web page shortly after the live broadcast after the live event is recorded.

To effect the streamlined publication of video programs or video program segments, methods of the present invention insert metadata tables and publishing instructions (collectively referred to hereafter as ‘publication characteristics’) into the script of a video program to be filmed. Subsequent to filming, the script is then used to parse and publish the video program on a web page, and/or as a group of video modules. The publication characteristics identify script elements such as the beginning and end of individual segments, the location and duration of transitions, the topical focus of the segments and additional elements (e.g., voice-overs, graphic elements, video roll-ins, flash files, etc.) typically included in video programs.

Referring now to the illustrative example of FIG. 2, a video program 13 having multiple video segments 4, 5, 6, 7, 8 is scripted, where the script includes publication characteristics identifying the multiple video segments 4, 5, 6, 7, 8 and a plurality of transitions 9, 10, 11, 12 residing in between the segments 4, 5, 6, 7, 8. According to one aspect of the invention, the individual video segments 4, 5, 6, 7, 8 are learning objects. The transitions 9, 10, 11, 12 are used to separate the individual segments 4, 5, 6, 7, 8 such that each learning object may later be identified, extracted and individually published to the Internet. Using the script and conventional filming methods known to those of ordinary skill in the art, an analog video program 15 is produced 14.

After production 14 of the analog video program 15, the analog video program 15 is converted 25 into a digital video program 16. As in the process illustrated in FIG. 1, the conversion of the analog video program 15 into a digital format such as MPEG-1, MPEG-2, AVI, or the like, may be executed by a computer executing conventional analog to digital video conversion software. According to one aspect of the invention, the conversion of the analog video program 15 to a digital video program 16 may occur concurrently with the filming of a live program. To convert analog concurrently or in real time, the analog camera equipment may be connected to a DVC pro-deck or other analog to digital video conversion equipment that can convert analog video to digital video concurrently or in real time. Typically, however, the analog video 15 is filmed using an analog camera, and a video editor must digitize the analog video from the analog video tape after the analog video program 15 is filmed. Once the video is digitized, it may be compressed before it is stored in digital form as the digital video program 16. Furthermore, it will be appreciated that if a live video program is recorded using a digital camera, the analog-to-digital conversion 25 need not be implemented. In such a scenario, the digital video program 16 is produced using the program 13 identifying the multiple video segments 4, 5, 6, 7, 8 and the plurality of transitions 9, 10, 11, 12.

In the example shown in FIG. 2, using the script and in particular, the publication characteristics therein, methods of the present invention automatically identify the learning objects by identifying scripted elements, such as the beginning and end of video segments or the occurrence of a segment transition within the digital video program 16. Because the identification of these elements occurs within the script, no additional effort must be expended during the digital production of the video to locate and extract the video objects.

As illustrated by the streamlined video publication process of FIG. 2, using the script a publisher can identify the five scripted segments within the digital video program 16: segment A 4, segment B 5, segment C 6, segment D 7, and segment E 8, where the segments are separated, respectively, by the four transitions 9, 10, 11, and 12. Together, the segments and transitions include a segmented, but complete, copy 26 of the digital video program 16 and analog video program 15. The segments 4, 5, 6, 7, 8 may be divided 28 into five individual video program segments (or course modules) 30 that each exist as individual objects publishable to the Internet, or a LAN or WAN.

According to one aspect of the present invention, one or more of the segments 4, 5, 6, 7, 8, such as segments 5, 7, 8 in the illustrative example of FIG. 2, may be associated by the publication characteristics. More particularly, one or more of the segments 4, 5, 6, 7, 8 may be associated by metadata tables within the script for the analog video program 8, such that one or more segments are published together in a video program or course. As shown in the example of FIG. 2, one or more segments may be published 32 to create a video program 34 comprising segments B 5, D 7, and E 8. It will therefore be appreciated that in the illustrative example of FIG. 2, the start and stop time of the five video segments 4, 5, 6, 7, 8, and the location of the transitions 9, 10, 11, 12, are known prior to filming the video program. These editorial elements are identified within the script and are utilized to parse the digital video program 16 into segments.

Next, FIG. 3 shows a block diagram illustrating a streamlined video publication process of the present invention, and devices for storing and downloading published video, according to one embodiment of the present invention.

As shown in FIG. 3, methods according to the present invention implement an authoring process 38 and publishing process 40 to effect the streamlined publication process described herein. The authoring process 38 arranges and produces video, such as the broadcast video of a live event. The publishing process 40 then extracts and publishes digital video or digital video segments therefrom. The purpose of the authoring and publication process is to identify digital video and/or digital video segment(s) that are publishable to the Internet as learning objects which may be combined with additional learning objects (e.g., other video segments) to create a web-based package including of multiple videos and/or video segments.

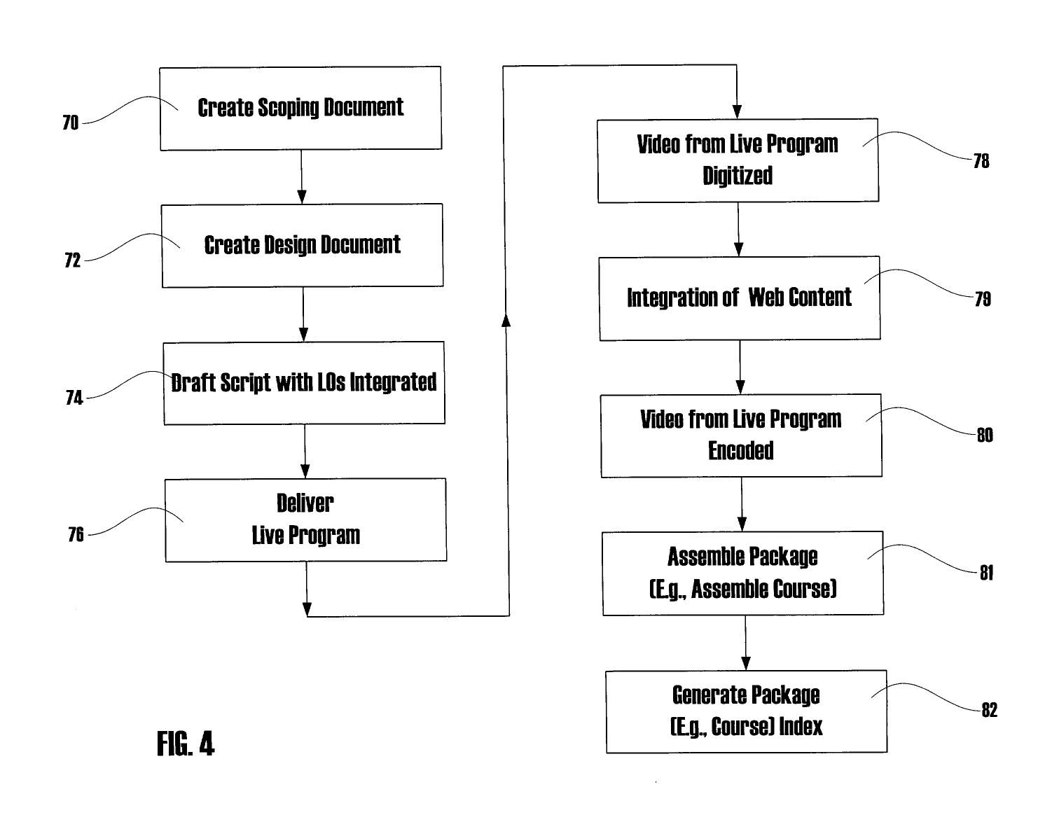

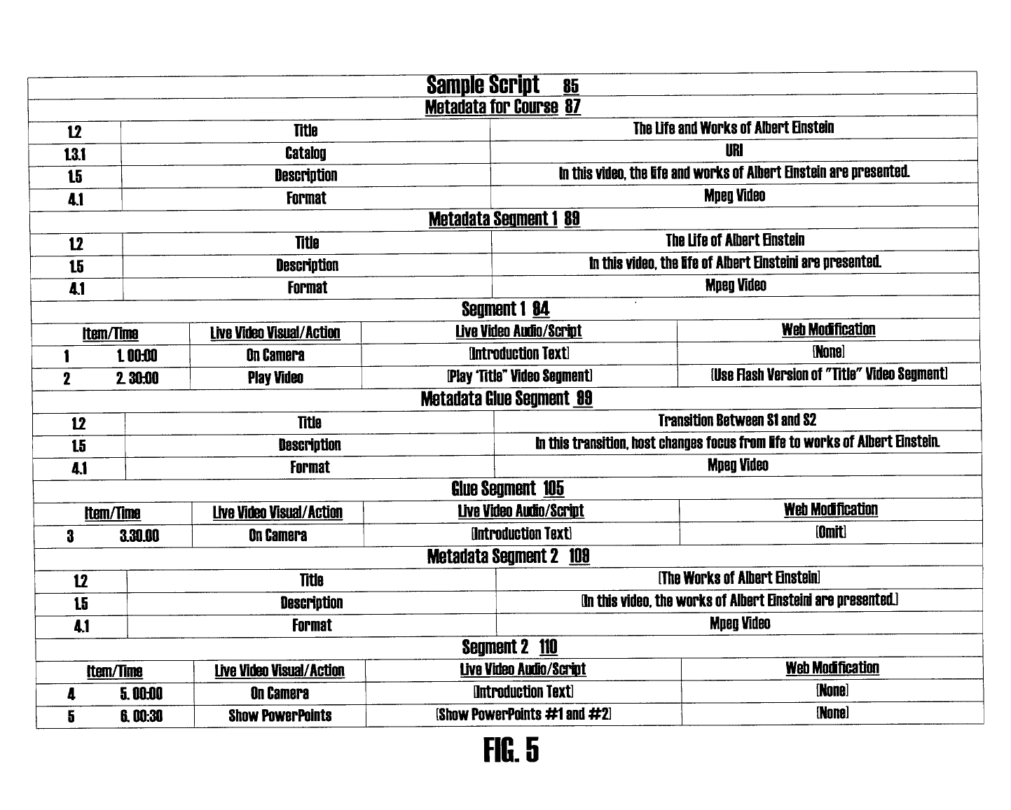

In particular, one or more scoping documents 43 and optionally, a treatment document, are utilized to create an initial design for a video program. The initial design of the program is specified in a design document 44 which serves as the blueprint from which the script is written. The design document identifies the publication characteristics that correlate to script elements, such as the beginning and end of video segments, topical foci, the location and duration of transitions, and any additional elements (e.g., voice-overs, graphic elements, video roll-ins, flash files, etc.) that are typically included in a live-video program. The design is edited and revised as necessary to ensure that the script is not only appropriate and complete for a live video program, but also to ensure that the script includes appropriate publication characteristics that will permit a publisher to parse and publish the program on a web page as it is filmed or immediately after it is broadcast. Thereafter the design document is used to incorporate the publication characteristics into the script. The publication characteristics, which are considered in greater detail in FIGS. 4 and 5, are expressly incorporated into the script during its creation 45 and during the editing and revision 48 process such that the present invention can utilize the characteristics to streamline the publication of some or all of the filmed event.

After the script for the video program is approved 50, the video event is filmed and optionally, broadcast 52. After broadcasting 52, which may occur if the video event is a live video event, the publishing process 40 utilizes the publication characteristics (i.e., metadata tables and publishing instructions) within the script to identify the individual learning objects. As previously discussed, the metadata may include the type of object, author, owner, format, pedagogical attributes, subject matter and the like. The metadata also includes necessary attributes to allow the object to be managed, located, evaluated, and associated with additional video segments or videos. Additionally, the publishing instructions identify additional information associated with the video segments, such as PowerPoint presentations, web content interactions, and content used during the creation of the video program.

According to a preferred embodiment of the present invention, the publication characteristics identify each learning object, along with its starting and ending position, its elapsed time, the location of the object in a combined presentation, and the additional media, if any, associated with the video. For instance, where a 30 or 60 minute instructional video is authored 38 and broadcast 52, the publishing process 40 may divide the instructional video into 1-15 minute segments based on editing instructions that have been authored into the script.

The identified video segments are learning objects that are extracted, assembled 56, and approved 58. The learning objects may then be indexed 60, which ensures that the metadata associated with each video or video segment is associated with the correct digital video segment. The learning objects may be stored in a digital repository 62 and published via a web or video server 64.

According to one aspect of the invention, the metadata is stored as an XML manifest file. The manifest file describes how to locate, manage, and sequence learning objects. One or more learning objects are then used to publish digital copies of the filmed video program, or segments of the filmed video program. A processor (not illustrated) or the web or video server 64 is operable to parse the learning object to extract its metadata and content. According to one aspect of the present invention, a learning management system (LMS) software application, as is known in the art, may operate on the web or video server 64 to create and deliver content using the one or more learning objects stored in the digital repository 62. Learning objects are accessed from the digital repository 62 for the creation of a web-based program, and its contents are stored on a web or network server 64 such that it can be accessed by a user via an Internet, LAN, or WAN 66. The user can view the one or more objects using a viewing device 68.

FIG. 4 shows a block diagram flow chart describing a method for automatically publishing a video to a web page, according to one embodiment of the present invention. First scoping documents are created 70 which define the needs and benefits of a video program, identify useable assets already in place, identify project constraints, requirements, and factors for consideration, and identify the program's goals, objectives and what needs to be developed. The generation of the scoping document 70 begins the process of breaking a video program into learning objects by identifying the modules, or segments, of the program. A design document is created 72 using the scoping document. As discussed with respect to FIG. 3, the design document provides information and instruction for developing a video program, including the program's organization and flow and key points (e.g., teaching points in the case of an instructional video), interactive strategies, assessment methods, and media elements used to explain any objectives of the video program.

After a script having learning objects identified therein is drafted 74 using the design document, the program is delivered 76. The video from the video program is then digitized 78. Next, learning objects are identified by the script metadata, and the publishing instructions within the script are used by a publisher to generate web content, including additional content elements used by the script of the program. In particular, learning objects are associated with web content such as digital pictures and other web content because the content and digital pictures are associated with and tied to the learning objects. After this integration of web content 79 occurs, the video from the program is encoded 80. Multiple learning objects may then be assembled 81 into a package of objects, also referred to herein as a course. Finally, the course is indexed 82, and checked into the digital repository for downloading by a user.

FIG. 5 shows a sample script 85 used in publishing a video program to a web page, according to an illustrative example of the present invention. As shown, the illustrative script 85 is directed to a video course having two segments (or learning objects) 89 and 109 connected together by a glue segment 105. As described below, glue segments refer to segments used to transition in between separate video segments. As illustrated in FIG. 5, the script 85 contains metadata describing course information including the title of the course, its catalog, its description, and its format. The script includes metadata for each of the two segments 89 and 109 within the course. The glue segment 105 also contains its own metadata 99. Additionally, each course and segment preferably contains a scripted editorial element identifying the beginning and ending of each segment, or learning object, such that the digital version of a filmed program can be readily parsed immediately after filming is complete. Because each learning object is tagged with metadata, it can be published to the Internet (or a LAN or WAN) individually or in combination with other learning objects. As such, it should be appreciated that the script may ensure that each segment is independent in that it does not make forward or backward references to other segments. Otherwise, such references may be confusing and out of context when segments are published as independent modules on the web.

Referring again to the illustrative example in FIG. 5, metadata for segment 1 89 includes information including the title, description, and format of the first segment, here, a segment on the life of Albert Einstein. After the metadata for segment 1 89 is defined, a web course segment may include an open segment (not illustrated), which may be a video and/or graphical introduction to the course and which identifies the beginning of a first video segment. Though not illustrated in FIG. 5, the open segment in the script would include its own metadata and video segment information, similar to metadata segment 1 89 and segment 1 94. It will be appreciated that a video program or course typically has one opening segment at the beginning of the program and one closing segment at the end of the program. However, the open for a live video program may differ considerably from an open implemented in a web course. For instance, an open for a live video may contain several elements such as a program title, a host welcoming the audience, a video showing how to use the student interactive system, and a program agenda, whereas a web course may not have an open, rather just the course title and a course menu.

Referring again to FIG. 5, after the opening of the segment, the filming of the video program occurs in the scripted sequence, here, beginning with Segment 1 94. The Item/Time”, “Visual/Action” and “Audio/Script” blocks within the illustrative script 85 of FIG. 5 are similar to those within any live-script and contain the dialogue and visual/action directions provided to the actors and film crew. After the first segment ends, metadata (not illustrated) marks the end of the segment. The glue segment 105 is included in the script to define a transition between the first and second segments 94, 110 of the video course. A glue object has no instructional value; rather, it provides transitional value and serves to connect video segments together in a cohesive manner. Upon publication, a web course may not contain any “glue” objects or, if creating a new course by combining learning objects (segments) from existing courses, may require new glue objects. Assuming that, for a video program, the glue content is something such as, “We have just learned about the features of the new. Now, let's look at the benefits of each feature” then the glue metadata might be as follows: Title: Transition from Features to Benefits; Description: In this transition, the host refocuses the audience from the features of the new to the benefits of each feature; Format: mpeg video. FIG. 5 therefore illustrates metadata for the glue segment 99, followed by the glue segment 105.

Next, segment 2 110 follows the glue segment 105. Like the course and segment 1, segment 2 110 has metadata 109 tagged to it which includes information including the title, description and format of the second segment, here, a segment on the works of Albert Einstein. After the metadata for segment 2 109 is defined, a second web course segment is opened (not illustrated), which identifies the beginning of a second video segment. As described above, the opening of the segment is indicated by metadata. The filming of the second segment occurs, as is illustrated by the ‘Item’, “Visual/Action” and “Audio/Script” blocks within the script. Finally, after the filming of the second segment is complete, segment 2 is closed, which marks the end of the second segment.

It will be appreciated that because the metadata is embedded within the script 85, a publisher can identify the metadata as it occurs concurrently with the filming of a program, or the broadcast of the live program. In this way, the boundaries of the program segments can be marked as the video is created, which then enables rapid breakdown of the content immediately following the program into either or both course modules and learning objects. This methodology represents a very significant savings in time over traditional approaches, which require substantial amounts of time to be spent in post-processing of the video to find and edit the material into discrete entities (i.e., course modules and learning objects).

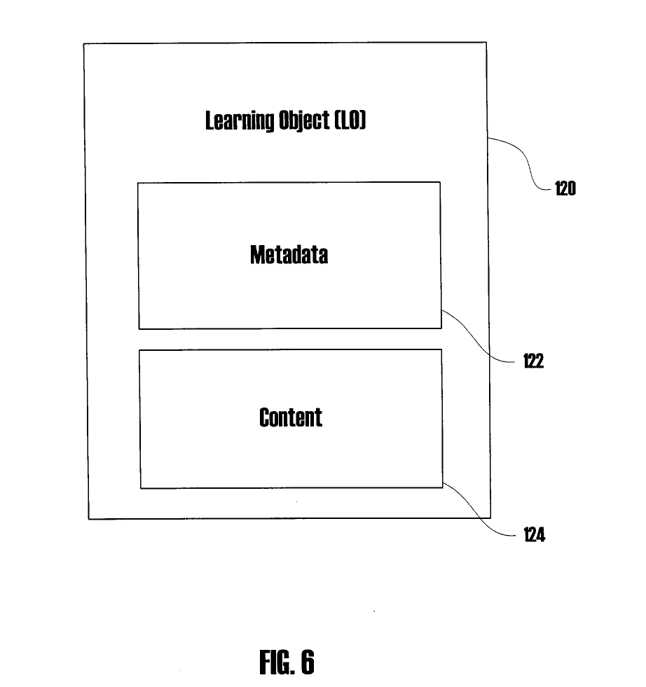

Next, FIG. 6 shows the basic structure of a learning object (LO) 120 according to the methods and apparatuses of the present invention. The LO 120 includes LO metadata 122 and LO content 124, which are stored within the digital repository 62 as noted with respect to FIG. 3. According to one aspect of the invention, the LO metadata 122 is stored in an XML file, which also contains information as to the LO content 124 associated with the LO 120. The LO content 124 is stored in a separate content file. A processor, or web or network server, parses the LO 120 to extract its LO metadata 122 and LO content 124, as is well known in the art. The web or network server then stores its components such that it can be accessed by an Internet or WAN user via a network connection.

Generally, a LO 120 represents physical media files (e.g., a video program) that may be transmitted and stored by a server for access by a user. LOs provide the means to manage the content required to implement a digital video program, including video, audio, images, executables, scripts, configuration files, text, fonts, HTML pages, and the like. The LO content 124 is the physical data, such as a video (e.g., an instructional program), media file, image, or other media content associated there with, while the LO metadata 122 is the data that describes the attributes of the LO content 124. For instance, where the LO content 124 represents an instructional video, the LO metadata 122 may include the instructional video title, a summary, its length, year made, and like data. In addition, the LO metadata 122 includes data identifying the type of LO and specific characteristics of the LO, such as the LO's structure. These identification and characteristics allow a processor or WAN or web server to determine what to do with the LO 120.

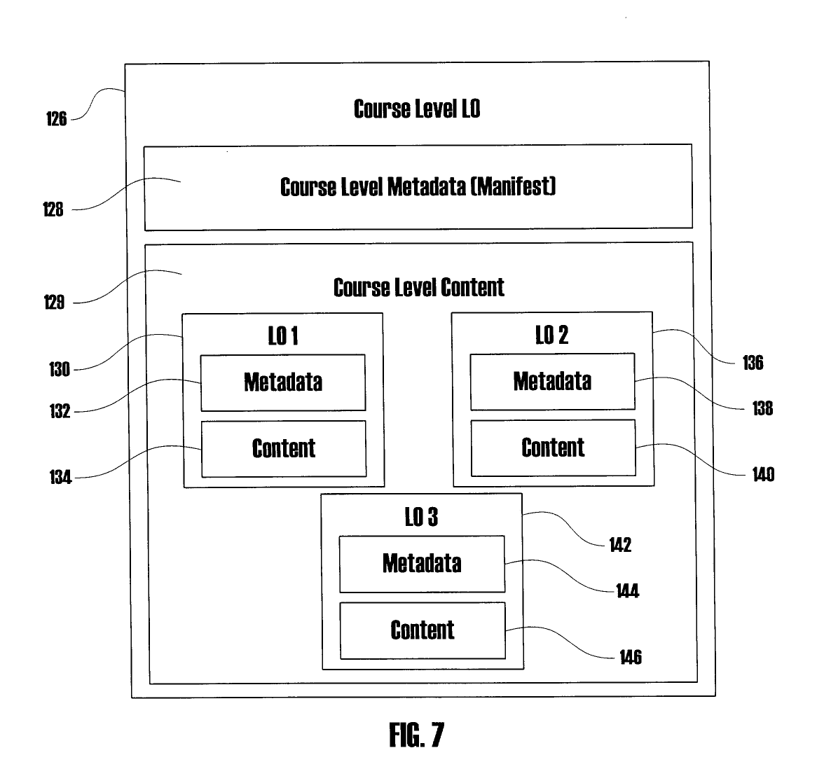

According to one aspect of the invention, a LO can also contain other LOs grouped together as a comprehensive lesson. Similar to the LO 120 of FIG. 6, the LO 126 illustrated in FIG. 7 includes LO metadata 128 and LO content 129. However, in the LO 126 of FIG. 7, the LO content 129 includes the three embedded LOs: LO 1 130, LO 2 136, and LO 3 142. Each of these LOs, in turn, include LO metadata 132, 138, 144 and LO content 134, 140, 146, respectively. Because a LO may be created that includes embedded LOs, material may be grouped together in a logical tree structure. As an example, where the topic of an instructional course is the repair of a flat tire, the course may contain instructional videos on jacking up/lowering a vehicle, repairing a flat tire using a patch or a plug, and removing/mounting a vehicle tire. Despite this relationship, it should be appreciated that FIG. 7 does not imply that one LO, such as an embedded LO, must be generated before the course level LO. According to another embodiment of the invention, a LO can be grouped in alternative manners, such as in parallel with other LOs. Thus, the three embedded LOs 130, 136, 142 combine to include the complete course, and may be organized in such a way to strongly encourage a web user to view the materials in a pre-defined sequence.

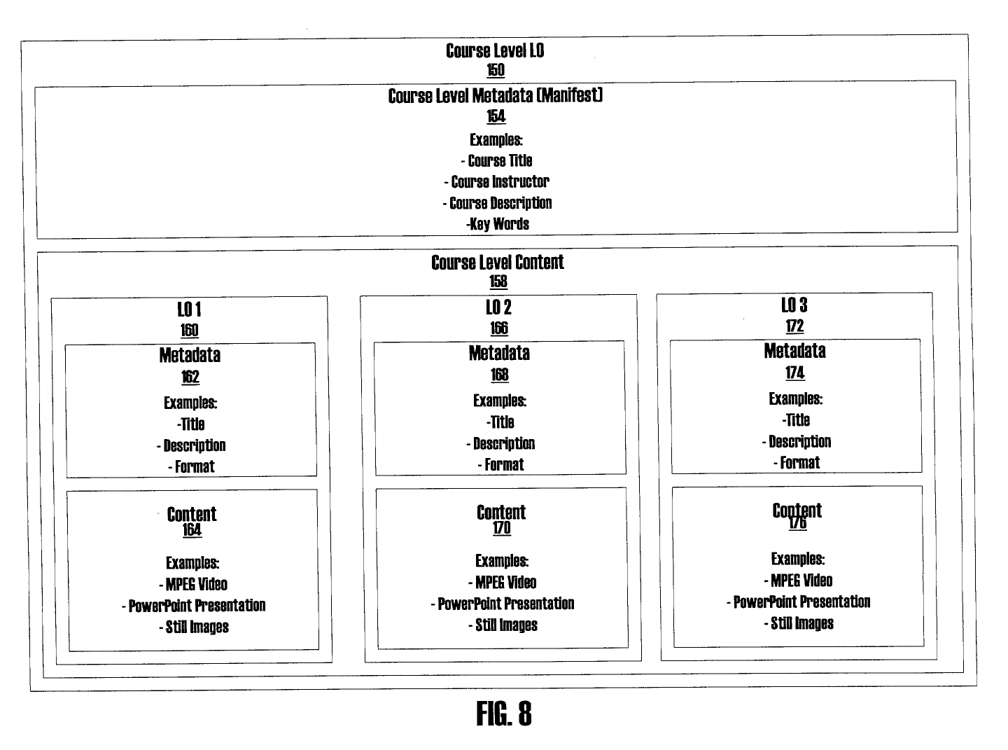

FIG. 8 shows an illustrative example of a learning object comprising a course, according to one aspect of the present invention. As illustrated in FIG. 8, the course 150 LO includes course metadata 154, which can include information such as the course title, course instructor, course description. The course metadata may also include information that represents attributes about the course as a whole. The course content 158 includes three embedded learning objects, LO 1 160, LO 2 166, and LO 3 172. Each of the learning objects are embedded within the course 150 as dictated by the relationship set out in the course script. For instance, referring to the sample script 85 of FIG. 5, the script would include learning objects directed to the two course segments, which in turn include their own metadata and content. Therefore, it will be appreciated that a script establishes the relationship between the course 150 and embedded objects 160, 166, 172 in the example of FIG. 8.

The three embedded learning objects, LO 1 160, LO 2 166, and LO 3 172, each include their own metadata that defines the attributes of the learning object content. Where the learning objects are each videos, the respective learning object metadata 162, 168, 174 define attributes such as the title of the associated video, and a summary of the video. Furthermore, each defines the attached content. The LO content 164, 170, 176 of each of the embedded objects includes the deliverable content, such as video, images and the like.

With reference to the above figures, it will be appreciated that LOs, including LOs having embedded LOs, are generated in a very efficient manner from a video program script including metadata that permits a publisher to efficiently parse and publish the live program on a web page as it is filmed or immediately thereafter. Because the metadata is expressly incorporated into the script during the creation of the script methods and apparatuses of the present invention can identify script elements, such as different segments, to automatically and immediately publish segments or all of the live event. Though the publication of digital video and/or video segments are discussed herein with respect to a web page, it will be appreciated that the present invention is applicable to publish efficiently video programs or program segments to other forms of media. For instance, where it is desirable to parse and organize and publish a large amount of analog content for digital publication, such as on a Digital Video Disc (DVD), the present invention provides an improved and streamlined publication method.

Many modifications and other embodiments of the inventions set forth herein will come to mind to one skilled in the art to which these inventions pertain having the benefit of the teachings presented in the foregoing descriptions and the associated drawings. Thus, it will be appreciated by those of ordinary skill in the art that the present invention may be embodied in many forms and should not be limited to the embodiments described above. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of publishing a video program segment, comprising:
identifying at least one video program segment in the script of a video program;
inserting metadata within the script prior to filming of the video program, wherein the metadata is associated with the at least one video program segment identified in the script;
using the metadata to identify the at least one associated video program segment after the filming of the video program using the script; and
publishing the at least one associated video program segment.

2. The method of claim 1, further comprising:
inserting at least one publishing instruction within the script; and
using the at least one publishing instruction to publish the at least one associated video program segment as a digital video program module.

3. The method of claim 2, further comprising using the metadata to associate a first digital video program module and a second digital video program module.

4. The method of claim 1, wherein publishing the at least one associated video program segment comprises making the published video program segment accessible via the Internet.

5. The method of claim 1, wherein inserting metadata within the script comprises inserting metadata within the script, wherein the metadata is associated with each of the at least one video program segments.

6. The method of claim 1, wherein inserting metadata within the script comprises inserting metadata identifying a title of the at least one associated video program segment.

7. The method of claim 1, further comprising storing the at least one associated video program segment prior to publishing the at least one associated video program segment.

8. The method of claim 1, further comprising storing the inserted metadata as a manifest file, wherein the manifest file identifies the location of the at least one associated video program segment.

9. The method of claim 1, further comprising creating a video program course using the script, wherein the video program course comprises a plurality of associated video program segments.

10. The method of claim 1, wherein publishing the at least one associated video program segment comprises digitizing the at least one associated video program segment.

11. The method of claim 1, wherein publishing the at least one associated video program segment comprises encoding the at least one associated video program segment.

12. A video program script for use in streamlining the publication of at least a portion of a video program filmed using the script, comprising:
a plurality of video program segments, wherein each of the plurality of video program segments are identified in the script by metadata; and
at least one visual direction associated with at least one of the plurality of video program segments, wherein the at least one visual direction is used to execute the filming of the video program.

13. The video program script of claim 12, further comprising at least one publishing instruction, wherein the at least one publishing instruction identifies publishing instructions for publishing the video program.

14. The video program script of claim 12, further comprising at least one publishing instruction, wherein the at least one publishing instruction identifies publishing instructions for publishing the video program on an Internet web page.

15. The video program script of claim 12, further comprising at least one glue segment, wherein the at least one glue segment provides a transition between two of the plurality of video program segments.
